(19) United States
(12) Patent Application Publication
(10) Pub. No.: US 2014/0216253 A1
(43) Pub. Date: Aug. 7, 2014

(54) CO2 Scrubber

(71) Applicant: Climate Strategy Inc., Winnipeg (CA)

(72) Inventor: Alan Scarth, Saanichton (CA)

(73) Assignee: Climate Strategy Inc., Winnipeg (CA)

(21) Appl. No.: 14/146,815

(22) Filed: Jan. 3, 2014

Related U.S. Application Data
(60) Provisional application No. 61/750,142, filed on Jan. 8, 2013.

(51) Int. Cl. B03C 3/017; E21B 43/16; B01D 53/14

(52) U.S. Cl. CPC B03C 3/017; B01D 53/1475; E21B 43/164
USPC 95/70; 95/57; 95/236; 166/305.1

(57) ABSTRACT

CO2 is extracted from the atmosphere by concentrating atmospheric air to form a first volume of the atmospheric air of increased level of CO2 and a second volume of reduced level of CO2, discharging the second volume back into the atmosphere and injecting the first volume into underground formations. The CO2 is concentrated by ionization and electrostatic separation of the charged particles from a stream and further concentration is carried out by molecular sieves. The first volume can be made miscible with oil and used to extract oil from oil-bearing formations or permanently stored in underground formations.

This application claims the benefit under 35 USC 119 (e) of Provisional Application 61/750,142 filed Jan. 8, 2013.

This invention relates to the capture of carbon dioxide (CO2)from the global atmosphere, the utilization of the CO2 for injection into oil formations to increase production of oil, the utilization of the CO2 for the production of carbonates for manufacture of cement, and the storage of the CO2 underground and compounded into carbonates, this capture and storage potentially qualifying for carbon credits or like incentives offered or paid to reduce the amount of carbon in the atmosphere.

### BACKGROUND OF THE INVENTION

### The History

Fossil carbon has done wonders for us in the last 200 years

As coal, it fuelled the steam engines which early on powered mills which spun cotton for affordable clothes, then it fuelled steam ship and train engines, and now it fuels generating stations which make electricity for our homes and factories.

As oil, it fuels the ships, aircraft and vehicles which now transport almost everything in our world.

As natural gas, it heats our homes, fuels turbines which generate electricity, and is beginning to fuel vehicles.

Fossil carbon fuel has provided the energy platform on which our modern technology has been developed.

This technology produces, preserves and transports enough food to sustain us. It has recently been reported that more of us are now dying of obesity than of malnutrition.

And this technology allows us to live healthier, longer and more productive lives than we did 200 years ago.

There were a billion of us then. There are seven billion of us now.

But this beneficial technological development which has been fuelled by burning fossil carbon has left us with a problem with our atmosphere which threatens to rob us of its benefits.

CO2 is produced when fossil carbon is burned, and this CO2 is being emitted into the atmosphere. These CO2 emissions are mainly responsible for overloading the atmosphere with carbon.

200 years ago, when the first steam engines were being fired up with coal, the carbon content of the atmosphere was about 280 parts per million (ppm). Today the carbon content of the atmosphere is about 400 ppm.

Our planet has been livable for us because a comfortable range of heat energy from the sun has been retained by an atmospheric blanket comprised in part of carbon compounds. This retained heat energy has been artificially increased by the extra CO2 we have emitted into to the atmosphere. Some of this extra CO2 has been absorbed by our natural biospheric systems, but these resilient systems couldn't absorb the whole load. The carbon content of the atmosphere has increased by about 40%, thickening our atmospheric blanket.

As a result of this thicker blanket, our average global temperature has increased by about 0.75 degree Celsius.

This increase in retained heat energy in the atmosphere is already making itself felt.

Winds are stronger. Rainfall is heavier. Sea levels are higher, both because of warmer water and ice melt.

Evaporation increases 10% for every 1 degree C. increase in surface temperature, so droughts are becoming more severe and protracted.

In a word, our weather is more extreme.

What we are beginning to understand is that this “extreme” weather is extreme only in an historical sense. It is in fact the new normal. When the weather reporters tell us about the many “record” temperatures, winds, floods and sea levels being experienced these days, the use of the word “record” implies that these are one-off events, not likely to be repeated. Given the rising global temperatures, these “records” are more accurately assessed as the baselines of a new era in our lives.

The infrastructure we have built, our buildings, our electrical systems, our seawalls, our levees, have been designed to withstand historical limits of wind velocity, sea surges and floods. Our agriculture has been adapted to historical limits of rainfall and drought. Our bodies are adapted to historical ranges of atmospheric temperature.

Weather events which exceed these historical levels, even by the relatively small margins now being experienced as a result of the current increase in heat energy, are already having a recognizable cost in lives and economic damage. Events like Hurricane Sandy are getting our attention.

At a UN conference in Copenhagen we talked about trying to reduce our CO2 emissions so that the increase in carbon in the atmosphere will be curbed, and the ultimate increase in average global temperature will be held to 2 degrees C.

At a more recent meeting in Doha, there was not much optimism that we can slow down CO2 emissions enough to hold to that 2 degrees C. target. As the Economist put it, “Achieving the stated goal of keeping climate change below 2 degrees C. by cutting carbon dioxide alone would require emissions to fall steeply for decades, starting within a couple of years. Few countries will countenance this . . . . ”

In The Economics of Climate Change: The Stern Review, Cambridge University Press 2007 Nicholas Stern makes the most comprehensive analysis yet of the effects of each degree of global warming, ranging from I degree C. to 5 degrees C. The effects on our food supply, our water, our sea levels, our forests, our species survival, and the rising intensity of storms, forest fires, droughts, flooding and heat waves, through this temperature range are represented graphically in a chart at page 330 of The Stern Review.

This Stern chart demonstrates that if we allow global temperatures to increase beyond 2 degrees C., our planet can no longer sustain all of us. There will not be enough food and water for the populations of many countries. Authorities like the United States Army warn that those of us made desperate by hunger and thirst will rebel against their governments, and the world will become unsafe for the rest of us. Gwynne Dyer describes this prospect in his book Climate Wars, Oneworld Publications, 2010.

### Our Options

Our technology having caused the overload of carbon in the atmosphere, we should be able to employ it either to extract that extra carbon from the atmosphere or to otherwise lower the amount of heat energy which accumulates there.

This developing technology is called “geoengineering”.

Volcanoes have given us the clue to the technology for the second option. Sulphur dioxide (SO2) and other vapor and particulates from erupting volcanoes have in the past persisted in the upper atmosphere and prevented some of the normal solar energy from reaching us. The resultant natural “winters” of reduced heat energy could be replicated by injecting SO2 vapor into the upper atmosphere, most conveniently by adding it to jet fuel. But this is a blunt instrument, carrying the risk of regional crop failures and starvation.

The first geoengineering option, removing more CO2 from the atmosphere, seems preferable in that it can be incremental, measurable and controllable in its impact.

This CO2 removal can be achieved by enhancing natural CO2 sinks. The oceans being the major sinks, experiments are proposed to treat the sea water with chemicals to enhance their capability of absorbing CO2. Again there is potential collateral damage when an ecosystem is altered.

This invention achieves the removal of CO2 from the atmosphere by capturing the CO2 and permanently storing it underground and as stable carbonates, with minimal impact on the ecosystems involved.

### Industrial Use

Under the entrepreneurial system which has driven our technological development in the last 200 years, it is not enough for an invention to have a longer term objective for the general benefit of all. The invention must meet an immediate commercial need if it is to be expeditiously employed on a meaningful scale.

James Watt's steam engine, which initiated our 200 year Industrial Revolution, met an immediate commercial need. Cotton mills had been tied to the flowing streams and rivers which powered their machines. The more efficient location for the cotton mills was adjacent to cities like Manchester, where larger work forces were becoming available and where there was a growing market for their product. A source of power adjacent to those cities was needed. The steam engine met that need.

The oil industry has a growing need for CO2 for injection into oil-bearing formations in order to push oil to oil wells. Current sources of CO2, natural underground reservoirs and flue gases from coal-fired plants, are mostly too distant from the oil wells, and inadequate in volume. Plants supplying CO2 at well sites will meet this need.

There is also a foreseeable need for large quantities of concrete to build sea walls to protect coastal buildings and infrastructure as sea levels rise. There will be a worldwide demand for calcium and magnesium carbonates to manufacture cement for those concrete walls. CO2 plants on site which supply those carbonates will meet that need.

### Carbon Credits

And as the need to remove carbon from the atmosphere becomes more and more evident, carbon credits or like incentives can be expected to be offered for capture and storage of carbon. Plants which capture CO2 and store it underground, or above ground compounded into stable carbonates, will be capable of earning those credits.

### SUMMARY OF THE INVENTION

### Capture of CO2

It is one object of the invention to provide a method of capturing CO2 from the global atmosphere and thereby reducing the amount of carbon compounds in the atmosphere.

According to one aspect of the invention there is provided a method for extracting CO2 from the atmosphere,

preferably by ionizing the CO2 molecules and directing the resultant CO2 ions by an electrostatic field so as to form a first volume of the atmospheric air of increased level of concentration of CO2 and a second volume of reduced level of concentration of CO2,

preferably further concentration of CO2 in the first volume is achieved by molecular sieves,

discharging the second volume back into the atmosphere,

and utilizing the first volume of concentrated CO2 in the following different applications, among others:

### Increasing Oil Production

The first volume can be injected into underground oil-bearing formations to push oil in increased volumes to oil wells.

### Producing Carbonates for Cement Manufacture

The first volume can be applied to a quantity of sea water, or other water with calcium and magnesium content, the sea water or other water having been treated to increase its alkalinity (pH), where the pH of the water can be preferably increased by electrolysis in a diaphragm cell, where the application of the first volume to the water results in the formation and precipitation of carbonate compounds, including calcium and magnesium carbonates, and the carbonates can be utilized by the cement industry to manufacture cement.

### Storage of CO2 and Carbonates

The first volume can be injected into a sealed underground formation where it will remain permanently stored,

As an alternative to utilizing the carbonates produced by applying the first volume to sea water or other water as set out above for cement manufacture, the carbonates can be stored permanently in the sea or other body of water, or on land.

The CO2 and the carbonates can be stored in such manner as to qualify the capture and storage of CO2 for carbon credits or like credits or payments, issued or made by governments or other agencies or persons with the intent and purpose of reducing the amount of carbon in the atmosphere.

### BRIEF DESCRIPTION OF THE DRAWINGS

Embodiments of the invention will now be described in conjunction with the accompanying drawings in which

FIG. 1 is a schematic illustration of a method of capturing CO2 from the atmosphere and applying the CO2 for increasing oil production or for storage underground in accordance with the present invention,

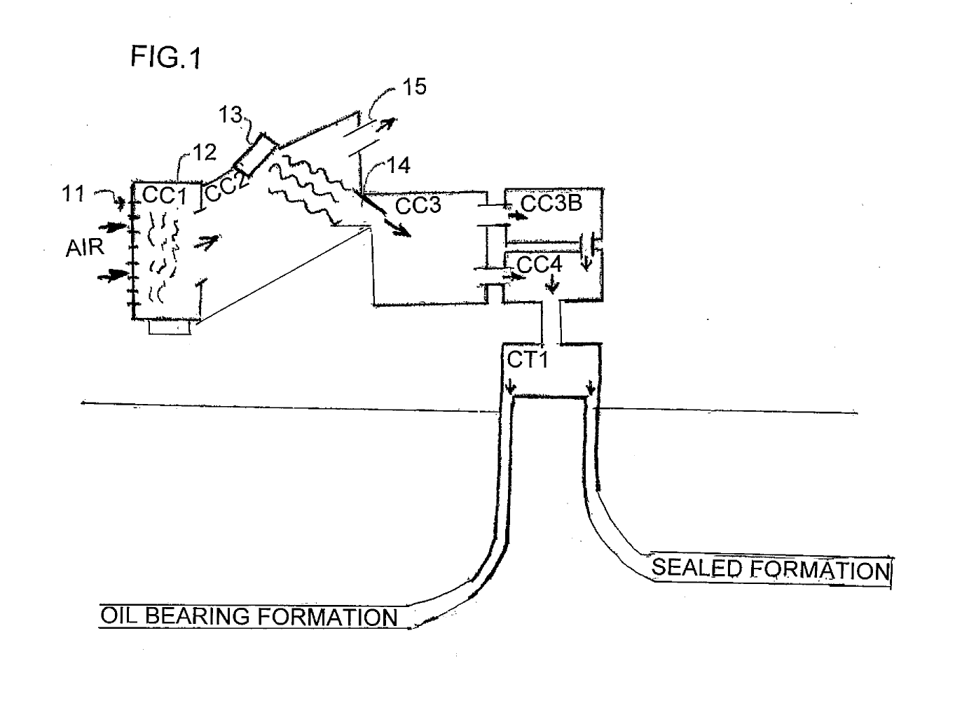

FIG. 2 is a schematic illustration of a method of capturing CO2 from the atmosphere and applying the CO2 to seawater to produce carbonates for the industry or for storage in accordance with the present invention.

### DETAILED DESCRIPTION

### Separation of CO2 by Ionization and Capture of CO2 Ions by Electrostatic Field

The invention proposes the ionization of CO2 molecules in the air in the natural ambient atmosphere at sea level and ground level, and the separation and capture of those ionized CO2 molecules by application of an electrical field.

CC1 provides an ionization chamber where ambient atmospheric air enters at an inlet 11 and CO2 molecules in the air are ionized or charged by an electron source 12 emitting a stream of electrons.

Air pressures within the ionization chamber may be reduced or increased, and the temperature within the ionization chamber may be reduced or increased, as may be required to increase the efficiency of the ionization of the CO2 molecules.

The ionization process may be repeated as may be required to increase the efficiency of the ionization of the CO2 molecules.

CC2 provides a separation chamber where ionized CO2 molecules are streamed by an electrostatic field 13 through a duct 14 into CO2 holding chamber CC3. The remaining air with lowered CO2 content following along its initial path from the inlet 11 passes through an outlet 15 and is vented to the atmosphere.

In an embodiment of the invention, ionization of the CO2 molecules in the ionization chamber is achieved by electrodes and the separation of the ionized CO2 molecules achieved by application of an electrostatic field at one electrode.

In an embodiment of the invention the air in the ionization chamber is exposed to ultraviolet light to ionize the CO2 molecules or to ionize additional CO2 molecules.

The separation of gas components in artificial and natural atmospheres by ionization is a scientific work in progress. The range of ionization and separation technology is described in the following documents and in the documents cited therein:

(2004) Separation of CO2 from artificial inert carrier gas atmospheres by ionization with soft X-ray and separation by applying an electrical field: Authors Takao Ito et al, Electrostatic Separation of Carbon Dioxide by Ionization in Bifurcation Flow, Aerosol and Air Quality Research, Vol. 4, No. 1, pp. 91-104, 2004.

(2008) Separation of oxygen from natural atmospheric air at low atmospheric pressures by ionization of molecular oxygen in an ionization chamber with a positive electrode at one end and a negative electrode at the other end, the resultant negative oxygen ions being attracted to the gas-permeable positive electrode and removed from the ionization chamber using two or more electric fields: Inventor Konrad Parsa U.S. Pat. No. 7,318,858 B2 GAS SEPARATOR FOR PROVIDING AN OXYGEN-ENRICHED STREAM.

(2007) CO2 molecules ionized in the atmosphere at higher altitudes to be propelled by Extremely Low Frequency (ELF) waves into the stratosphere where the Earth's magnetic field carries the CO2 ions to the poles where they are transported upwards into space: Laboratory Modeling of Space experiments on Expulsion of CO2 ions. Application to Global Warming. Wong, A Y, 2007, Eos Trans. AGU, 88(23), Jt. Assem. Suppl.

The disclosures in the above documents and in documents cited therein are incorporated herein by reference.

CCSB provides a molecular sieve to increase concentration of the CO2 stream. This is optional and only provided if required.

### CO2 Pumped Into Underground Oil-Bearing Formations to Increase Oil Production.

This process, known as Carbon Dioxide Enhanced Oil Recovery (CO2EOC), is well developed and profitably employed by the oil industry, primarily for tertiary production of oil from oil-bearing underground formations.

Primary production is achieved by employing the natural ambient pressure in the formation to push the oil in oil-bearing formations towards producing wells. Secondary production has generally been achieved by pumping water-based liquid into the oil-bearing formations to push the oil towards producing wells.

After primary and secondary production, more than half of the initial volume of oil in oil-bearing formations may remain unproduced.

CO2EOC is employed as a tertiary production process to produce this residuary oil in the oil-bearing formations.

The CO2EOC process is described in Carbon Dioxide Enhanced Oil Recovery, Untapped Domestic Energy Supply and Long Term Carbon Storage Solution, National Energy Technology Laboratory, U.S. Department of Energy. March 2010. (USDE).

In this embodiment of the invention, a Compression Chamber CT 1. is provided into which the CO2 is streamed and in which the CO2 is compressed under controlled temperature so that the CO2 is miscible with the oil in the oil-bearing formation into which the CO2 is injected.

The injection of volumes of miscible CO2 into the oil-bearing formations may be alternated with the pumping of water into the oil-bearing formations, a process known as water alternating gas or WAG.

The virtue of this embodiment of the invention from the perspective of the oil industry is that mobile plants capturing, concentrating and compressing CO2 can be located on well sites, so that supplies of miscible CO2 will be available as required for injection into oil-bearing formations.

CO2 which reaches the producing wells and is produced with the oil is separated from the oil produced and recompressed in the Compression Chamber CT 1. for reinjection into the oil-bearing formation, so that the retention and storage of the CO2 in the oil-bearing formation is permanent.

### CO2 Injected Underground Into a Non-Oil-Bearing Formation Where It is Permanently Sealed Off

In this embodiment of the invention, whether or not carbon credits or like incentives to capture and store carbon are available, the CO2 is injected into an underground formation at a pressure compatible with the pressure in that formation so that when the formation is sealed off the CO2 is permanently retained and stored in that formation.

### CO2 Bubbled Through High pH Seawater to Form Stable Carbonate Compounds

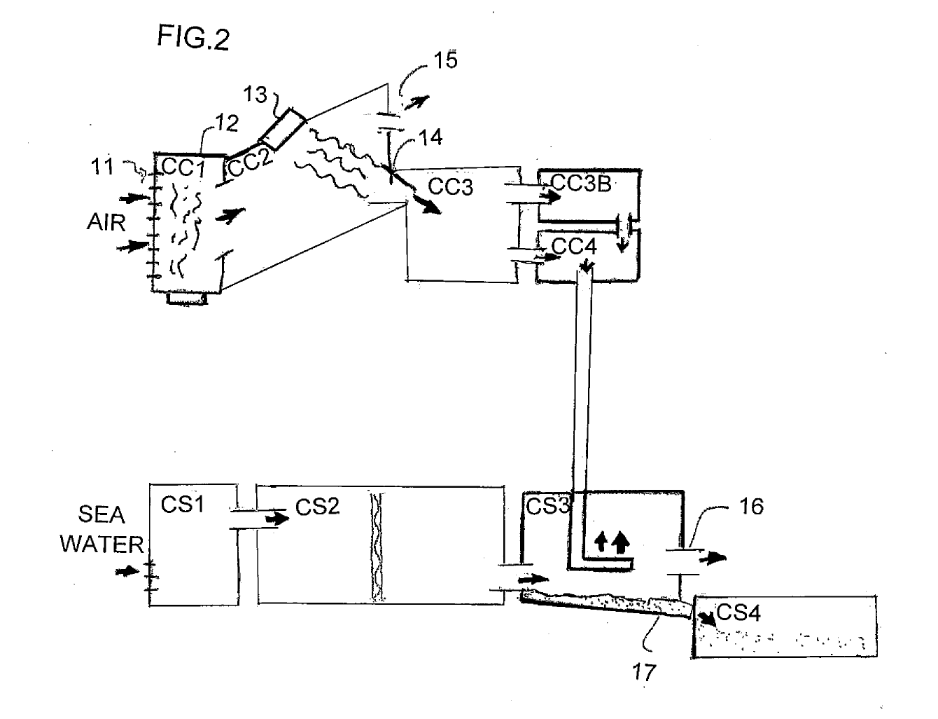

In this embodiment of the invention, seawater is prepared as shown in FIG. 2.

Natural seawater is introduced into Initial Treatment Tank CS1, where it is treated to remove contaminants which might interfere with processes, including but not confined to electrolytic processes, applied to increase the pH of the seawater.

In U.S. Pat. No. 7,966,250 (Constantz and Khosla) issued Jun. 21 2011 and previously published as 2010/0063902A1 dated Mar. 11, 2010, titled “CO2 COMMODITY TRADING SYSTEM AND METHOD” is disclosed a technology which causes the bubbling of flue gases from industrial plants through sea water to capture the CO2 in those gases and store it as carbonates. Calera, the California cement company of the co-inventor Vinod Khosla is said to be using the sea water technology described to produce carbonates in a slurry, which it dries and processes to make a white cement.

The disclosure of the above patent is incorporated herein by reference to provide disclosure of the known techniques for introducing the CO2 gas into sea water.

The present proposal is different in that it uses arrangements for concentration of the atmospheric CO2 from the atmospheric air for injection into sea water, rather than injecting flue gases as does the above patent process.

The difference is significant in terms of the global effect on the CO2 loading of the atmosphere. A plant using the Flue Gas patent technology would at best be CO2 neutral, having burnt fossil fuel to produce the CO2 and then attempting to capture the CO2 in the flue gas by bubbling it through sea water. The present technology will act to capture CO2 already in the atmosphere, and will thus achieve a net reduction in the CO2 in the global atmosphere.

The technology proposed herein to enhance the ocean's ability to convert our concentrated CO2 to a carbonate and thus store it, is well known. Adding common chemicals to the sea water, as disclosed in the above Constantz patent, can enhance the production of carbonates and mitigate the initial release of CO2.

Constantz and Khosla et al proposed to bubble CO2 through seawater to precipitate carbonates.

This invention enhances the pH of the seawater before bubbling CO2 through it.

Treated seawater is directed from the Initial Treatment Tank CS1. into the pH Enhancement Tank CS2.

In one embodiment of the invention a Diaphragm Cell, a well-known technology. is employed in the pH Enhancement Tank to increase the pH of the seawater. The Cell Effluent has a sufficient component of sodium hydroxide to raise the pH of the Cell Effluent to the level required to enable precipitation of carbonates including but not confined to calcium carbonate and magnesium carbonate (the carbonates) when CO2 is bubbled through the Cell Effluent in the Precipitation Tank CS3.

In one embodiment of the invention an industrial plant applying the invention is energized exclusively by solar energy and the electrical energy applied to the diaphragm cell is adjusted in intensity and time to accommodate the solar energy available.

The carbonates precipitated in the Precipitation Tank CS3 are flowed as a slurry into the Carbonate Treatment Tank CS4 where the slurry may be dried or otherwise prepared for industrial use, including the manufacture of cement.

### Stable Carbonate Compounds Permanently Stored in Water or on Land

In one embodiment of the invention, whether or not carbon credits or like incentives to capture and store carbon are available, the slurry in the Precipitation Tank CS3 is flowed into a body of water or into a holding area on land where it is permanently stored with due consideration of the impact of such storage on the affected ecosystems.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in any limiting sense.

1. A method for extracting CO2 from the atmosphere comprising:
concentrating atmospheric air to form a first volume of the atmospheric air of increased level of CO2 and a second volume of reduced level of CO2;
discharging the second volume back into the atmosphere;
and injecting the first volume into underground formations.

2. The method according to claim 1. wherein the CO2 is concentrated by ionization of the CO2 and by electrostatic separation of the charged particles from a stream of the atmospheric air;

3. The method according to claim 2. wherein further concentration is carried out by molecular sieves.

4. The method according to claim 1. wherein the first volume is made miscible with oil and used to extract oil from oil-bearing formations.

5. The method according to claim 1. wherein the first volume is permanently stored in underground formations.

6. A method for extracting CO2 from the atmosphere comprising:
concentrating atmospheric air to form a first volume of the atmospheric air of increased level of CO2 and a second volume of reduced level of CO2;
discharging the second volume back into the atmosphere;
and applying the first volume to a quantity of water of pH sufficiently high so as to form carbonates in the water;
wherein the formation of the carbonates from the first volume acts to reduce the quantity of CO2 in the atmosphere.

7. The method according to claim 6 wherein the carbonates are extracted for commercial use.

8. The method according to claim 6. wherein the carbonates are stored at the sea bed or on land.

9. The method according to claim 6. wherein the pH of the seawater or other water is increased prior to mixing with the CO2 of the first volume.

10. The method according to claim 9. wherein the pH is increased by electrolysis.

11. The method according to claim 6. wherein the CO2 is concentrated by ionization of the CO2 and by electrostatic separation of the charged particles from a stream of the atmospheric air.

12. The method according to claim 11. wherein further concentration is carried out by molecular sieves.
